(19) United States
(12) Patent Application Publication
(10) Pub. No.: US 2017/0308636 A1
(43) Pub. Date: Oct. 26, 2017

(54) METHODS AND APPARATUS FOR A COIL DESIGNER

(71) Applicant: Texas Instruments Incorporated, Dallas, TX (US)

(72) Inventors: Pradeep Kumar Chawda, Cupertino, CA (US); Makram Monzer Mansour, San Jose, CA (US); Jeff Perry, Cupertino, CA (US)

(21) Appl. No.: 15/492,977

(22) Filed: Apr. 20, 2017

Related U.S. Application Data
(60) Provisional application No. 62/325,327, filed on Apr. 20, 2016.
(60) Provisional application No. 62/375,033, filed on Aug. 15, 2016.

(51) Int. Cl. G06F 17/50

(52) U.S. Cl. CPC G06F 17/5077; G06F 2217/06; G06F 2217/12

(57) ABSTRACT

A computerized PCB coil circuit design system includes an input engine to receive PCB coil design parameters based on manufacturing rules including trace width and conductor thickness, to receive input parameters including LC sensor capacitance, coil shape, and number of coil layers, and to receive updates to any of the PCB coil design parameters or the input parameters. The system further includes a PCB coil solution generation engine to calculate output coil parameters including total inductance, sensor frequency, and Q factor as a function of the PCB coil design parameters and received input parameters, to graphically plot one selected output parameter as a function of one input parameter, and upon an update to one parameter selected from the parameters based on PCB manufacturing rule and input parameters, to recalculate the output coil parameters and to replot the one selected output coil parameter as a function of one input coil parameter.

### CROSS-REFERENCE TO RELATED APPLICATIONS

This application claims the benefit of priority under 35 U.S.C. §119(e) to co-owned U.S. Provisional Patent Application No. 62/325,327 filed on Apr. 20, 2016, titled “COIL DESIGNER,” and also to co-owned U.S. Provisional Patent Application No. 62/375,033 filed on Aug. 15, 2016, titled “COIL DESIGNER,” each of which is hereby incorporated by reference in its entirety herein.

### TECHNICAL FIELD

This relates generally to circuit design tools, and more particularly to tools for the design of coils.

### BACKGROUND

An inductance-to-digital converter (LDC) circuit in its simplest form includes a spiral coil placed on a printed circuit board and connected to an LDC integrated circuit device. A change in distance between the coil and a target, typically a metallic object, changes the inductance (L) in the coil, and this change can be sensed. The LDC may be used to determine the distance between the coil and the target based on the inductance. Changes in the distance may, in turn, be used to detect some event, for example, that a button housing the target has been pressed. The design of effective LDC sensor circuits depends on the design of robust PCB coils, i.e., coils laid out on a printed circuit board.

Developing a coil design with satisfactory performance from the myriad of available combinations of input parameters is a very tedious and time-consuming task. A coil design tool that allows a designer to efficiently design a PCB coil that meets desired performance characteristics is needed.

### SUMMARY

In a described example, a computerized PCB coil circuit design system includes a user input engine: to receive PCB coil design parameters based on PCB manufacturing rules including trace width (W) and copper thickness (t); to receive user input parameters including inductor-capacitor (LC) sensor capacitance (C), coil shape, and number of coil layers (M); and to receive updates to any of the PCB coil design parameters or the user input parameters. The computerized PCB coil circuit design system further includes a PCB coil solution generation engine to: calculate output coil parameters including total inductance (L), sensor frequency (f), and Q factor as a function of the PCB coil design parameters and received user input parameters; to graphically plot one selected output coil parameter as a function of one input coil parameter; and upon an update to one parameter selected from the parameters based on PCB manufacturing rule and user input parameters, to recalculate the output coil parameters and to replot the one selected output coil parameter as a function of one input coil parameter.

### BRIEF DESCRIPTION OF THE DRAWINGS

FIG. 1 is an illustration of a device, including an LDC circuit used as a sensor.

FIG. 2 is an illustration of a device for measurement between a target and a pair of sensors connected to an LDC.

FIG. 3 is a graph providing an example of the change in inductance in the coils of a device such as that of FIG. 2 based on a distance to a target.

FIG. 4 is an example circuit layout of a device on a printed circuit board including a PCB coil and an LDC.

FIG. 5 is a high-level flow chart illustrating steps taken in designing a PCB coil using circuit design tools of the embodiments described herein.

FIG. 6 is a high-level architecture diagram of a system for implementing a PCB coil design tool of the embodiments.

FIG. 7 is a block diagram illustrating an alternative embodiment of a PCB coil design tool system.

FIG. 8 is a flow chart illustrating the process flow of a PCB coil design tool system such as shown in FIG. 6 and FIG. 7.

FIGS. 9 through 14 depict an example illustration of a graphic user interface (GUI) provided by the PCB coil design system of FIG. 6 and FIG. 7.

FIG. 15 provides a matrix of available parameters for graphing in the PCB coil design system of FIG. 6 and FIG. 7 using the user interface of FIGS. 9 through 14.

FIGS. 16, 16A, 16B are a flowchart illustrating the process the PCB coil design solution generation engine of FIG. 6 and FIG. 7 used to produce a PCB coil layout.

FIGS. 17A and 17B illustrate stacked coils and non-stacked coils, respectively.

FIG. 18 is an illustration of a simple spiral coil illustrating coordinates of points on a spiral coil.

FIG. 19 is an illustration of a plan view of an anticlockwise spiral coil and of a clockwise spiral coil, both with an inner offset.

FIG. 20 illustrates in a plan view the placement of line segment endpoints on a counterclockwise spiral coil.

### DETAILED DESCRIPTION OF EXAMPLE EMBODIMENTS

Corresponding numerals and symbols in the different figures generally refer to corresponding parts unless otherwise indicated. The figures are not necessarily drawn to scale.

The term “PCB coil” includes planar coils laid down on printed circuit boards in various geometric shapes in one or more layers. A PCB coil may be in multiple layers. Furthermore, PCB coils may include multiple coils arranged in parallel or in series.

The term “LDC circuit” refers to a circuit that includes at least one PCB coil connected to an inductance-to-digital converter such as the LDC1000 commercially available from Texas Instruments Incorporated.

The design of circuit components, including the design of PCB coils, is often a tedious exercise in which many different combinations of parameters must be weighed against each other to satisfy certain design goals as efficiently as possible. The embodiments disclosed herein include a circuit design tool, specifically, a circuit design tool useful in designing PCB coils. PCB coils can be used in sensors with inductance-to-digital conversion (LDC) circuits. LDC circuits are useful as sensors to provide a precise measurement of position or motion of a target object relative to a sensor. An example is detecting whether a button integrating a target has been pushed.

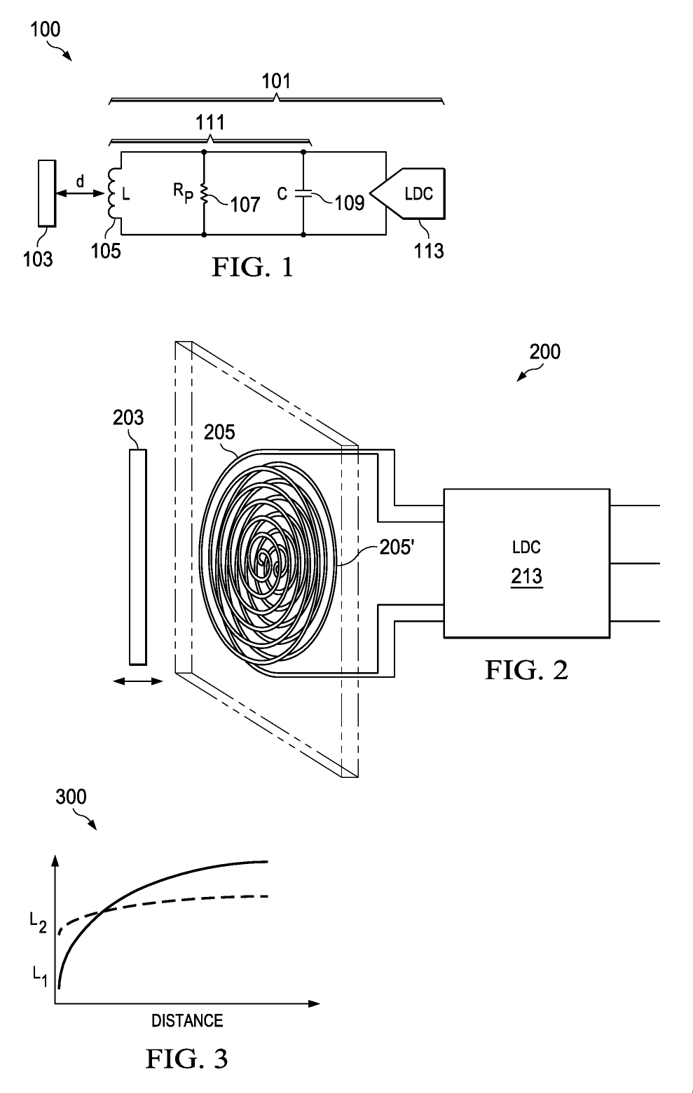

FIG. 1 is an illustration of a device 100 including a simple LDC circuit 101 used as a sensor to make a precise determination of the distance, d, between a target 103 and a PCB coil 105 of the device 100.

The PCB coil 105, which has an inductance L, is connected in parallel with a resistor 107 and a capacitor 109 forming an LC-circuit 111. The LC circuit 111 is a tank circuit in which electrical energy oscillates between the inductor and the capacitor at a frequency which depends on the inductance and the capacitance of the circuit.

The frequency of the oscillations depends on the inductance L of the PCB coil 105. If the target 103, typically made of metal, is brought closer to the coil 105, eddy currents occur in the coil 105. These eddy currents change the inductance of the coil 105, which, in turn, changes the frequency of the LC-circuit 111.

The LC-circuit 111 is connected to an inductance-to-digital converter (LDC) 113. The LDC 113 detects the frequency of the oscillations in the LC-circuit 111, from which the distance d may be determined. The LDC 113 may be connected to a processor 115 for further processing of data obtained, for example, interpretation of an observed change in distance d as being indicative of a user pressing a control button of the device 100. Proximity detection of objects and additional applications can be implemented using the system 100, in addition to sensing button pushes. The embodiments can be used to design coils for a wide variety of applications in addition to the examples described.

FIG. 2 is an illustration of a device 200 to illustrate precision measurement between a target 203 and a pair of sensors, connected to an LDC 213. The two sensors are composed of PCB coils 205 and 205′. As in the illustration of FIG. 1, the two coils 205 and 205′ are components of respective LC-circuits, having independent frequency responses to movement of the target 203 with respect to the sensors.

In the embodiment illustrated in FIG. 2, the two PCB coils 205 and 205′ are stacked with respect to each other. In alternative embodiments, the PCB coils 205 and 205′ may be located in other arrangements vis-à-vis each other, e.g., adjacent to each other in the same plane, thereby being useful for detection of a movement of the conductive target 203 in a plane parallel to the plane of the PCB coils. Similar to device 100 of FIG. 1, the two PCB coils 205 and 205′ are connected to an LDC 213, which, from inductance of the two PCB coils 205 and 205′, determines location of the target 203 with respect to the coils 205 and 205′.

Because the inductance of the two coils 205 and 205′ reacts differently to movement of the target 203, the relationship between the inductance of the two coils is a useful measurement for precise detection of the location of the target 203 relative to the two coils. FIG. 3 is a graph 300 providing an example of the change in inductance in the coils 205 and 205′ based on a distance to a target 203. When the target 203 is very close to the sensors, the inductance L1 (of coil 205) is less than the inductance L2 (of coil 205′). (Note this is an example, and for different coil designs, the relationships between the inductances can vary). However, when the target 203 is moved away from the sensors, while the inductance of both coils increase, the inductance L1 (of coil 205) increases more markedly until it is greater than the inductance L2 (of coil 205′). Thus, the relative inductance values and changes in the relative inductance values may be used to determine the movement of the target 203 vis-à-vis the sensors.

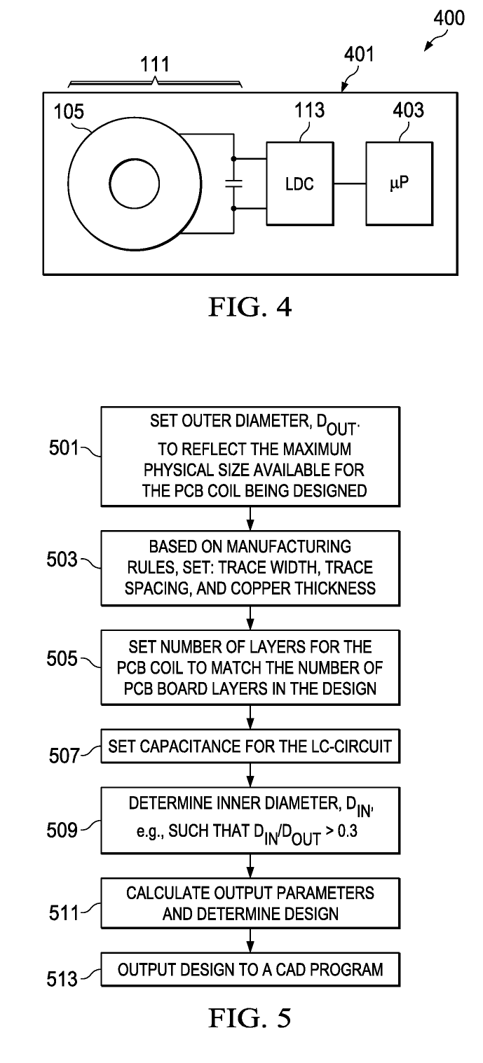

A circuit design has to take many factors into account. FIG. 4, which includes similar elements to the elements presented in FIG. 1, is an example circuit layout of a device 400 on a printed circuit board 401 including a PCB coil 105 and an LDC 113. The circuit may include a microprocessor or microcontroller 403, an LDC 113, an LC-circuit 111 including a PCB coil 105. There may be size constraints on circuit components, for example, due to the intended placement of the device 400 in a machine or an appliance. Thus, the designer of the PCB coil 105 has to consider certain physical characteristics, e.g., the maximum outer diameter allowed to be able to occupy allocated space on the printed circuit board 401. Furthermore, the design of the PCB coil 105 may require adherence to circuit design rules for the printed circuit board 401, such as minimum trace width and conductor thickness. Typically the conductor is copper or a copper alloy, while the embodiments can also be used with other coil materials. With all such factors in mind, ultimately the PCB coil should also satisfy certain performance objectives.

FIG. 5 is a flow chart illustrating the major steps performed in designing a PCB coil using circuit design tools described herein.

In a first step 501, the maximum physical size of the PCB coil 105 is determined that may be used in the intended application. The value Dₒᵤₜ, the outer diameter, is set to the maximum physical size available for the PCB coil 105.

Next, based on PCB manufacturing rules, the values for trace width and trace space are set, step 503, as well as conductor thickness. In this example the conductor is copper. Typical value for trace width and trace space if 4 mils (0.1 mm) or 6 mils (0.15 mm). For purposes of increased electrical conductance, the thicker the copper or other conductor layer, the better. A typical value may be 1 oz-cu (˜35 μm).

In step 505, a PCB coil may be composed of several layers. In a preferred embodiment, the available number of layers is selected from 1 through 8. The number of layers is typically set to match the number of board layers in the design. The number of layers of the coil can be less than the number of board layers in an alternative arrangement.

In step 507, the capacitance of the LC-circuit 111 is set. Typical range is 500 pF to 2 nF unless a specific sensor frequency is required.

In step 509, the inner diameter is typically best set so that the ratio between the inner diameter, Dᵢₙ, and the outer diameter, Dₒᵤₜ, is greater 0.3, i.e., Dᵢₙ/Dₒᵤₜ>0.3. Several parameters defining a PCB coil depend upon each other. For example, with a given trace width and trace spacing, the inner diameter may be indirectly set by setting the number of turns of the PCB coil 105 thereby achieving the desired Dᵢₙ′Dₒᵤₜ ratio given the trace width and trace spacing parameters.

In step 511, the output parameters are determined from the corresponding input parameters by performing calculations. These calculations, which are discussed in greater detail hereinbelow, include: calculation of total inductance; sensor frequency; and Q factor.

In step 513, once the design satisfies desired design goals, the design may be exported to a computer aided design (CAD) format for further circuit design using additional design tools. In step 513, a PCB coil 105 may be manufactured on a PCB 401.

As there are many adjustable parameters in a coil design, there is a myriad of possible parameter combinations. Accordingly, a preferred embodiment circuit design tool provides a mechanism by which a circuit designer may change the parameters and efficiently realize how such changes affect the ultimate design in terms of performance parameters. The process may be iteratively performed until a desirable design has been achieved. Rapid comparisons between completed coil designs can be achieved using the embodiments.

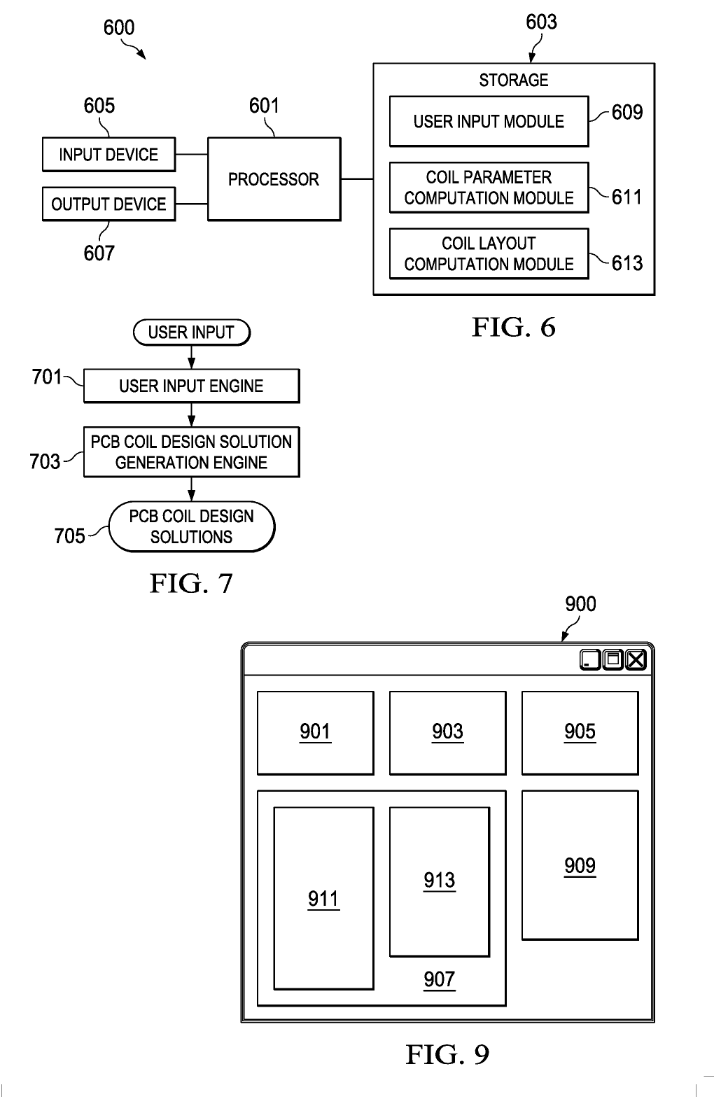

FIG. 6 is an architecture diagram of a system 600 for implementing a computerized PCB coil design tool. The design tool of the embodiments allows a designer to adjust parameters and to efficiently realize how the changed parameters affect the design. The PCB coil design tool, for example, implemented in system 600, allows a user to simulate many design possibilities, understand how changes to parameters impact other parameters, and, upon having achieved a coil design that satisfies design goals, to export the design into a CAD program format for manufacturing.

The computerized PCB coil design tool system 600 includes a processor 601 connected to a non-transient storage unit 603, which stores software programs and data, and coupled to an input device 605 and an output device 607. The processor 601 may be a single processor or a plurality of processors. The processor can be, for example, a personal computer, a mobile device, a workstation computer, or any other computer system. The processor can be implemented using programmable commercially available devices including microprocessors, microcontrollers, digital signal processors (DSPs), mixed signal processors (MSPs). Semi-custom devices such as application specific integrated circuits (ASICs), which may include processor cores such as embedded DSPs, and may include cores such as reduced instruction set computers (RISC) cores or advanced RISC machines (ARM) cores. User configurable integrated circuit devices such as field programmable gate array (FPGA) and complex programmable logic devices (CPLDs) can be used. Personal computers, workstations, laptops, tablet computers and other computing devices configured to execute software programs can be used to perform the embodiments.

The input device 605 may include a keyboard and a pointing device, e.g., a mouse. The output device 607 may include a computer display, or a printer to produce an output.

The processor 601 may be a server computer connected to the input device 605 and output device 607 via web-browser program executing on a computer (not shown) connected to the processor 601 via a computer network, for example, the Internet.

The non-transient storage unit 603 has a user input module 609 for providing user interfaces, for example, web pages, to the processor 601 for display on the output device 607. The user input module 609 further includes instructions for the processor 601 to receive parameter values and option settings set directly or indirectly by a user operating the input device 605. These parameter values, set via the user input module 609, include the parameters set during steps 501 through 509 of FIG. 5 and includes a mechanism provided to a user to activate the output mechanism to output a PCB coil design to a CAD program as described in conjunction with step 513.

The non-transient storage unit 603 further includes a coil parameter computation module 611. The coil parameter computation module 611 contains instructions for the processor 601 to use input parameters received via user input module 609 to calculate output parameters for a PCB coil corresponding to the input parameters.

The coil parameter computation module 611 may further contain instructions to calculate one or more output parameters as a function of one or more input parameters. Such calculation of the functional relationship between input and output parameters may then be used to calculate graphs illustrating expected changes in the output parameters due to possible changes in input parameters as illustrated and discussed hereinbelow in conjunction with FIGS. 9 through 13.

The non-transient storage unit 603 further includes a coil layout computation module 613. The coil layout computation module 613 contains instructions for the processor 601 to use the input parameters input from a user using the user input module 609 and the output parameters for a PCB coil corresponding to the input parameters calculated by the computation module 611. Based on these input and output parameters, the computation module 613 calculates a PCB layout for a PCB coil corresponding to the input parameters and the calculated output parameters.

FIG. 7 is a block diagram illustrating an alternative embodiment of a computerized PCB coil design tool system according to the herein disclosed principles. As illustrated in FIG. 6, the processor 601 executes one of the modules 609 through 613 stored in the storage unit 603 and thereby becomes an “engine” for carrying out particular tasks of the PCB coil design process.

As illustrated in FIG. 7, the user input module 609 (FIG. 6) executed by processor 601 (FIG. 6) forms a user input engine 701. The coil parameter computation module 611 and coil layout computation module 613 executed by the processor 601 forms a PCB coil design solutions generation engine 703. The PCB coil design solutions generation engine 703 accepts the user inputs 700 from the user input engine 701 to calculate PCB coil output parameters and to produce PCB coil design solutions 705.

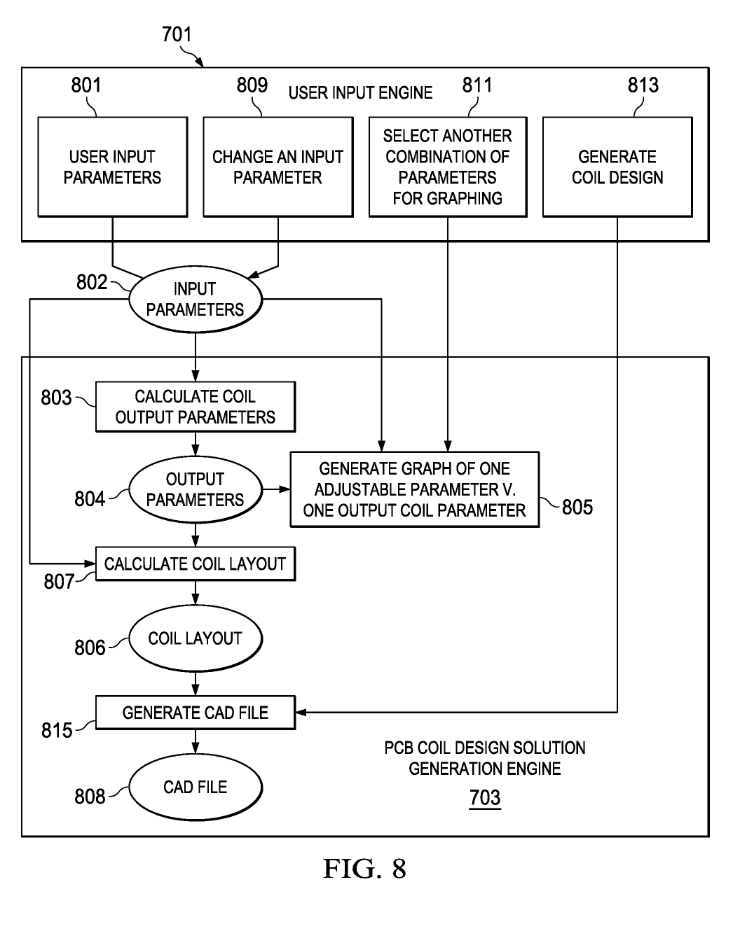

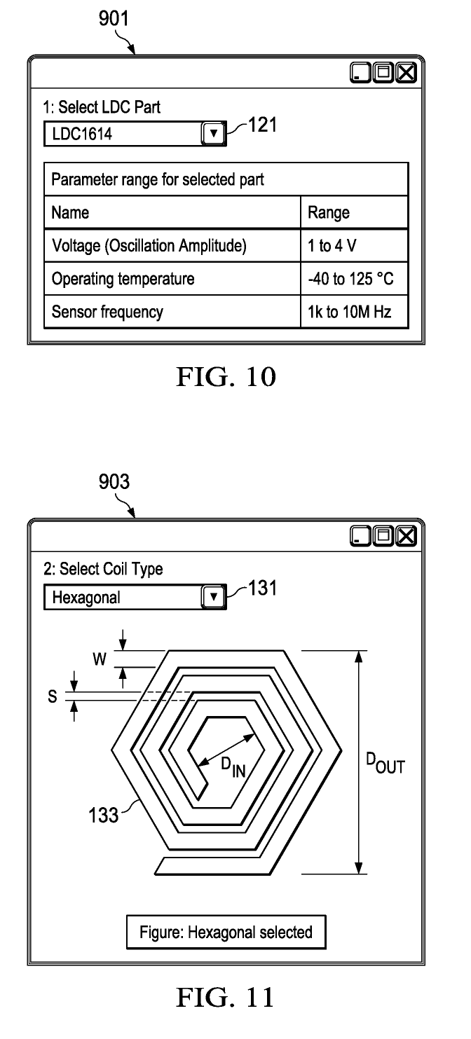

FIG. 8 is a flow chart illustrating an example process flow of a PCB coil design tool system such as 600 in FIG. 6. A user inputs, at step 801, user settable input parameters 802. The user settable input parameters 802 are used to calculate, at step 803, PCB coil output parameters 804. The user settable input parameters 802 are discussed in greater detail hereinbelow, for example, in conjunction with FIGS. 10-12. The input parameters 802 and output parameters 804 are used to generate graphs, at step 805, illustrating functional relationship between selected input parameters 802 and output parameters 804. The input parameters 802 and calculated output parameters 804 may also calculate, at step 807, a PCB coil layout 806.

The user input engine 701, i.e., the execution of the user input module 609 on the processor 601 in FIG. 6, may be used by the user to manipulate input parameters at step 809, including coil shapes, and control the graphical output, at step 811, by selecting different combinations of parameter values to graph against each other. A change in an input parameter 802 in the user input engine 701 causes the PCB coil design solution generation engine 703 to recalculate, at step 803, the coil output parameters 804 and, consequently, to regenerate the graphical illustration, at step 805. The updated parameters may also cause the PCB coil design solution generation engine 705 to update the coil layout, at step 807.

The user may also make changes to the graphical illustration, at step 811, for example, the user selects another combination of parameters for which to provide graphical illustration. In response to a change in the combination of parameters for graphing, the PCB coil design solution generation engine 705 regenerates the graph, at step 805.

Finally, as the ultimate goal of the PCB coil design system 600 is to design a PCB coil such as 105 for placement on a printed circuit board such as 401, a user may indicate the desire to generate a CAD file representing the designed coil. The user input engine 701 provides the user a mechanism by which to direct, step 813, the PCB coil design solution generation engine 705 to generate a CAD file 808, at step 815.

Turning now to the user interface provided by the PCB coil design system 600, FIG. 9 shows an example illustration of a graphic user interface (GUI) 900 provided by the PCB coil design system 600. The GUI 900 may be displayed on the output device 607 and receive input from a user via the input device 605. The GUI 900 includes five windows 901 through 909, with window 907 containing two sub-windows 911 and 913.

Window 901, illustrated in FIG. 10, provides a mechanism by which a user may select a particular LDC device that is to be used in the design of a PCB coil. In the example shown in FIG. 10, the user has selected LDC1614 from Texas Instruments Incorporated. The menu 121 may be used by the user to select any of several different LDCs. In addition, the user can create a custom coil design compatible with some other integrated circuit or other user defined circuitry, by choosing a custom part in this window. In response to the user's selection of a particular LDC model in the menu 121, the system 600 displays, in the output portion of window 901, certain parameters pertinent to that LDC part, for example, the voltage (oscillation amplitude), the operating temperature, and the sensor frequency may be output in the output portion of window 901. The menu 121 may also provide a user a mechanism to override such parameters, for example, for a custom part or for a part not available through the menu 121. That is the user can select an option to design a coil without specifying an LDC listed in menu 121.

Window 903, illustrated in FIG. 11, provides a mechanism by which the user may select one of several different coil shapes via a drop down menu 131. Examples of coil shapes that may be included in the drop down menu include circular, square, rectangular, hexagonal, octagonal, triangular, stretched triangular, and race-track (an oval-like shape with circular ends and straight sides like a top view of a race-track). In response to the selection, the PCB coil design solution generation engine 705 recalculates the corresponding output parameters 804 and displays a coil shape that corresponds to the selection and those calculated parameters in the display sub-window portion of window 903.

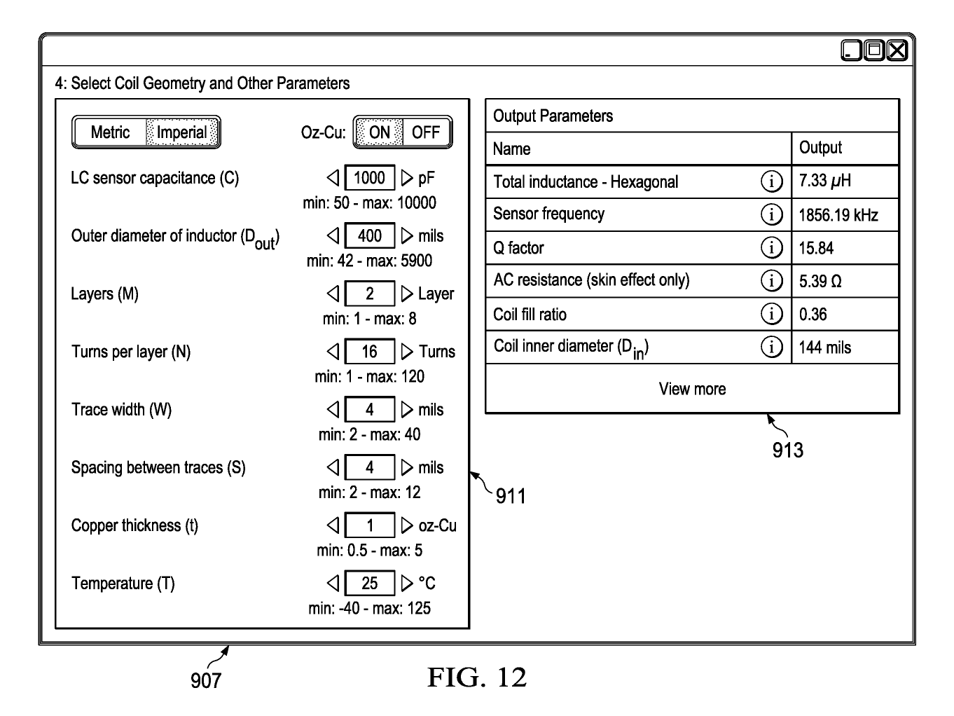

Window 907, illustrated in FIG. 12, is a user interface window with two subwindows: user input parameter window 911; and output parameter window 913. The user input parameter window 911 is used by the user to set input parameters. In a preferred embodiment, the input parameters include LC sensor capacitance (C), Outer diameter of the inductor (Dₒᵤₜ) (the inductor is the PCB coil 105), number of layers (M) of the PCB coil 105, Turns per layer (N), Trace width (W), Spacing between traces (S), Copper thickness (t), and Temperature (T). It should be noted that the number of layers (M) typically is made to match the number of layers of the printed circuit board 401. Further, the values Trace width (W), Spacing between traces (S), and Copper thickness (t) are typically set based on printed circuit board design rules. Note that for a design for a different manufacturing process, a conductor other than copper can be used. However, a user may override these values.

It should further be noted that some of the input parameters depend on other input parameters. For example, a change in the Trace width (W) has an effect on the outer diameter (Dₒᵤₜ) and vice versa. Thus, a change in one would impact the other. Select relationships are provided hereinbelow in the section entitled “PARAMETER VALUE RELATIONSHIPS.”

Given the part number set in the menu 121 of the LDC part window 901, the coil shape selected in drop down menu 131 of window 903, and the input parameters set in the input parameter window 911, output parameters of the resulting PCB coil 105 are computed (step 803 of FIG. 8) and output in the output parameter window 913. These output parameters include: Total inductance; Sensor frequency; Q factor; AC resistance (skin effect); Coil fill ratio; and Coil inner diameter (Dᵢₙ). Other output parameters calculated (but not displayed in FIG. 12) include DC resistance, Average diameter, Geometric mean diameter, Self-inductance per layer, Coil length per layer, Skin depth, Self-resonant frequency, Resonance impedance, Current, Power dissipation. The section hereinbelow entitled “CALCULATIONS” provides formulas and code examples useful for calculating a selection of these output parameters.

Many output parameters are calculated from Mohan's equation, Equation 1:

L=[(μ₀N²D_{AVG}C₁)/2][ln(C₂/ρ)+C₃ρ+C₄ρ²] (1)

where:

L is the total inductance

μ₀ is the permeability of free space, 4π×10⁻⁷

N is the number of turns of the coil

D_{avg} is the average diameter=(Dₒᵤₜ+Dᵢₙ)/2

C₁, C₂, C₃, C₄ are layout dependent factors based on the geometry of the coil (for a circle, the following values are appropriate: C₁=1.0, C₂=2.46, C₃=0, C₄=0.2. C coefficients for other shapes may be found in [Mohan])

ρ is (Dₒᵤₜ−Dᵢₙ)/(Dₒᵤₜ+Dᵢₙ), and represents the fill ration of the inductor− small values of ρ correspond to hollow inductors (Dₒᵤₜ≈Dᵢₙ), while large values correspond to (Dₒᵤₜ≈Dᵢₙ)

Equation 1 for L provided above may be derived from Mohan's Equation, as discussed in [Mohan] S. S. Mohan, M. del Mar Hersheson, S. P. Boyd, and T. H. Lee, “Simple Accurate Expressions for Planar Spiral Inductances,” IEEE Journal of Solid-state Circuits, vol. 34, no. 10, pp. 1419-1424, Oct. 1999 (the entire disclosure of which is incorporated herein by reference). It can be readily seen, from Equation 1, the equation for inductance, that a change in a parameter such as outer diameter (Dₒᵤₜ) has a direct or indirect impact on the inductance L.

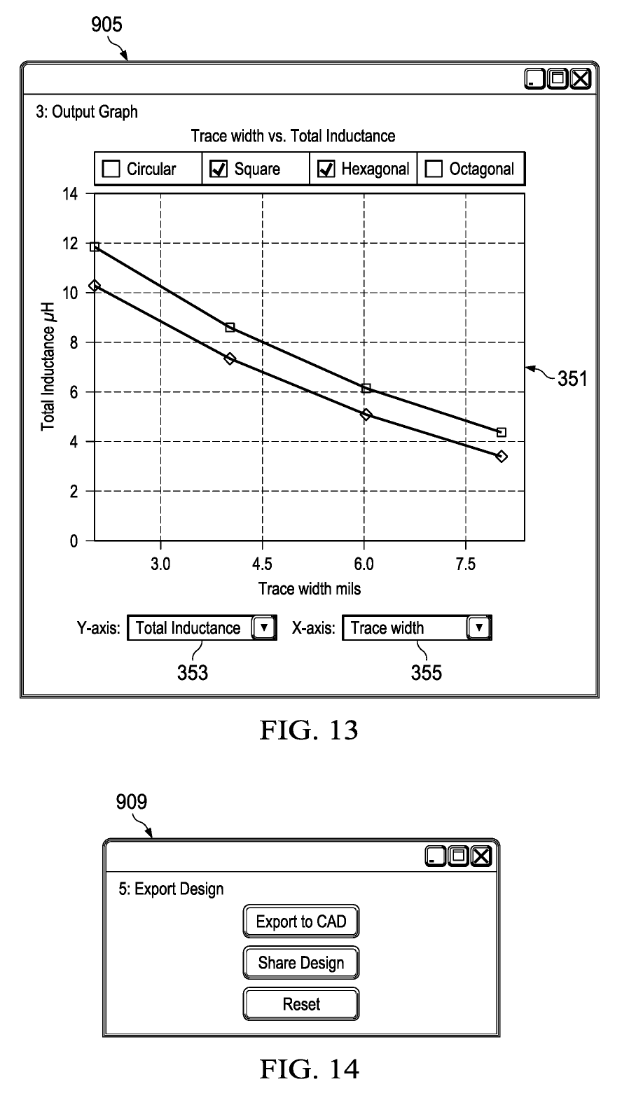

Window 905, illustrated in FIG. 13, provides a graph of the relationship of one parameter as a function of another parameter. In the example of FIG. 13, a graph 351 is a plot of the total inductance (TotalInductance) of the PCB coil 105 against the trace width (input parameter Trace Width) for two different coil shapes, Square and Hexagonal. In this example embodiment, a user may select to plot graphs for any of the available shapes, i.e., Hexagonal as in the example, also Circular and Octagonal (as noted above, in a preferred embodiment other shapes, such as, stretch-triangular and race-track, are also available).

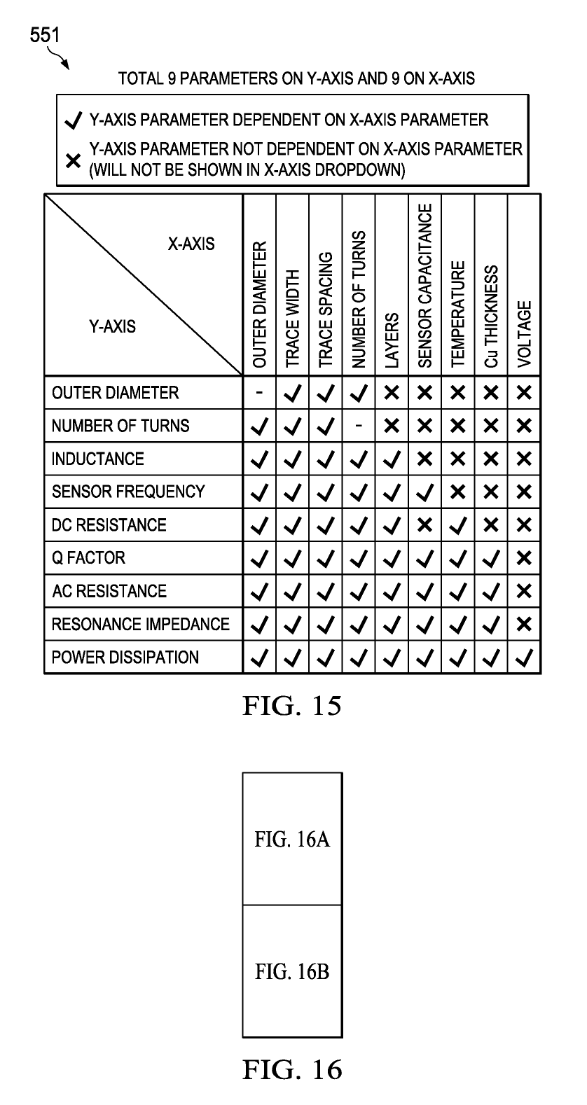

A user may use the drop down menus 353 and 355 to select which values to plot against each other. FIG. 15 provides a matrix 551 of available parameters for graphing. A check mark (✓) in a matrix cell corresponding to one input parameter and one output parameter indicates that parameter pairing is available for graphing, as these parameters have a dependency relationship. Conversely, an (x) in a matrix cell indicates that there is no dependency relationship between two parameters and that these two parameters are therefore not available for graphing.

The section entitled “CALCULATIONS” hereinbelow provides calculations and example code useful for and related to the graphing of parameter values in window 905.

Window 909, illustrated in FIG. 14, provides control buttons allowing a user to initiate the export of a PCB coil design to a CAD program or to share the design, for example, by export to a shared file repository or an email program. The Window 909 also provides a reset button used to reset the input parameters to default values if a user desires to start over.

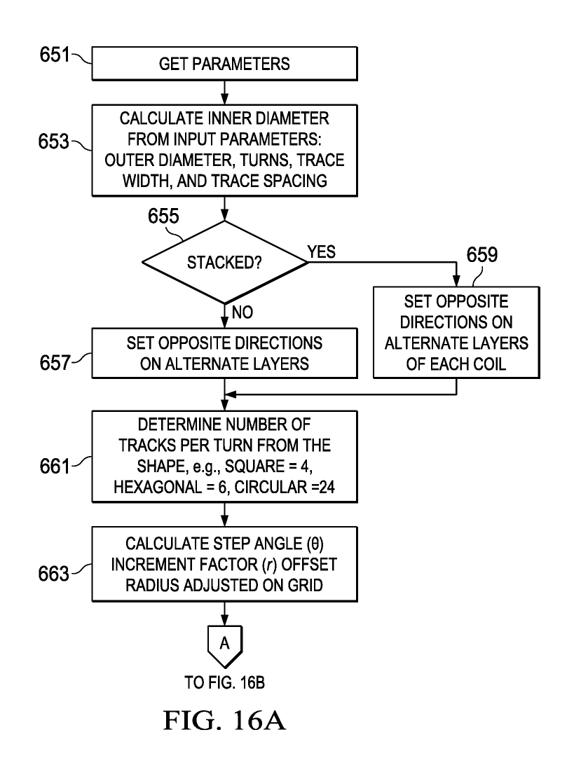

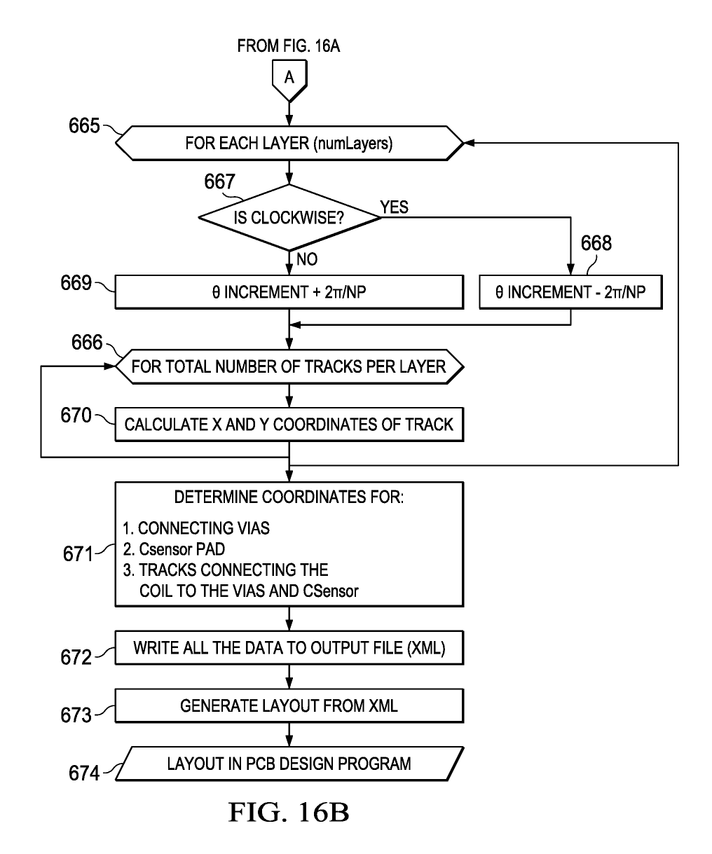

Turning now to the calculation of a coil layout, FIGS. 16, 16A and 16B present a flowchart illustrating the process used by the PCB coil design solution generation engine 703 to produce a coil layout. According to an embodiment, a coil is laid out as a number of connected line segments called tracks. For a polygon shaped coil, the tracks are simply the sides of the polygon with a slight offset per turn for producing a polygon shaped coil. A spiral shaped coil is approximated by a polygon with a large number of sides. Each track is defined by coordinates for the endpoints of the track. Thus, the coil layout calculation determines the coordinates for each track that the coil is made up of.

The following notations apply:

θ—the track subtend angle, also known as the step angle, i.e., the angle between two vectors extending from the coil center to the two track endpoints, respectively.

Rᵣ—radius increment per turn

R_{T}—radius increment per track

W—trace width

S—trace spacing

Dᵢₙ—offset radius, i.e., the distance from the coil center to the starting point of the coil

θ₀—offset angle

x1, y1, x2, y2—end point coordinates of a track

T—tracks per turn

Shape—e.g., circular, square, hexagonal, octagonal

N—turns per layer

M—number of PCB layers

P(rₚ, θₚ)—is a point on the coil defined, in polar coordinates, by radius rₚ and angle θₚ

In a first step 651 in FIG. 16A, “GET PARAMETERS”, the PCB coil design solution generation engine 703 retrieves the input parameters 802 and calculated output parameters 804. The relevant parameters include whether the design is for a stacked coil, e.g., as illustrated in FIG. 2 (isStacked), number of layers (numLayers, M), shape of the coil (shape), outer diameter of the coil (Dₒᵤₜ or outerDiameter), number of turns (numTurns, N), trace width (trace Width, W), and trace spacing (traceSpacing, S).

In a step 653 in FIG. 16A, the PCB coil design solution generation engine 703 calculates the inner diameter (Dᵢₙ) from the outer diameter (Dₒᵤₜ), number of turns (numTurns, N), trace width (trace Width, W), and trace spacing (traceSpacing, S), using Equation 2:

Dᵢₙ=Dₒᵤₜ−N*W−(N−1)*S (2)

Next, the flow depends on whether the user selected design calls for stacked coils or for a design without stacked coils, step 655, as this impacts how windings of layers are oriented. For non-stacked coils, the layers are set in opposite direction on alternating layers, step 657. Conversely, for stacked coils, the directions of the windings are in opposite directions for the alternate layers of each coil, step 659. However, adjacent layers of two stacked coils have the same winding orientation.

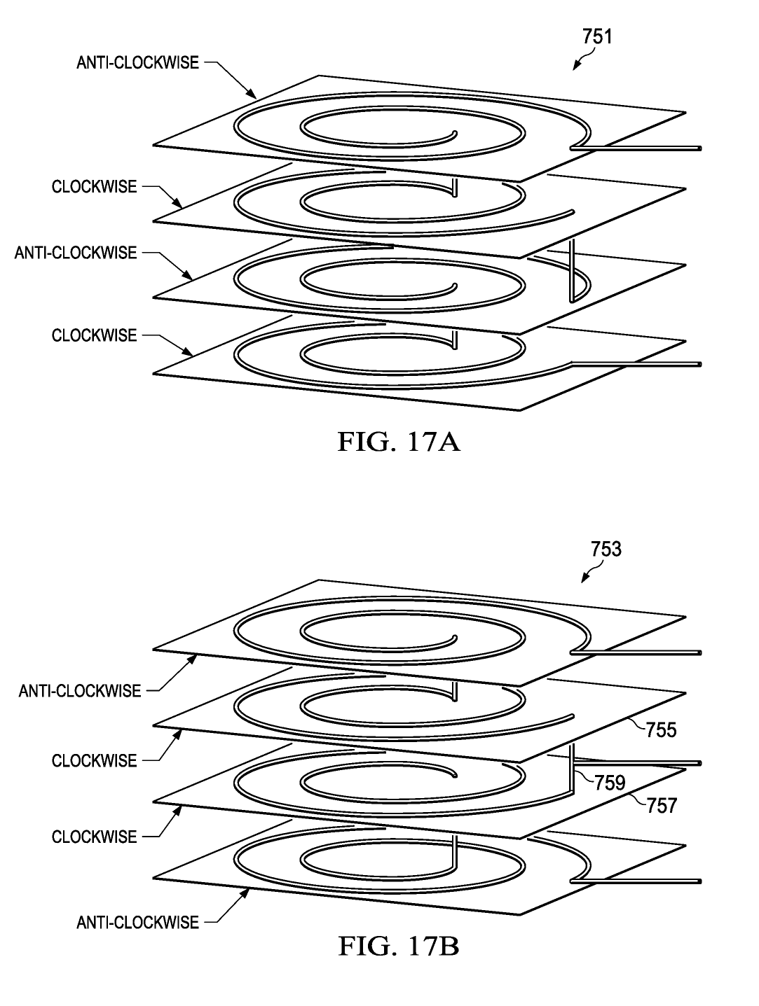

FIGS. 17A and 17B illustrate stacked coils and non-stacked coils, respectively. FIG. 17A illustrates a non-stacked coil. For non-stacked coils, e.g., as the four-layer coil 751, the layers alternate between clockwise and anti-clockwise from the bottom layer to the top layer. Stacked coils, e.g., coil 753 of FIG. 17B, may have two adjacent layers with the same winding orientation, e.g., the two middle layers 757 and 769, which are the layers where the two stacked coils connect at 759, are both clockwise.

Referring back to FIG. 16A, in a step 661, the PCB coil design solution generation engine 703 determines the number of tracks per turn, N_{T}, from the coil shape. For various polygons, the number of tracks is simply the number of sides of the polygon, e.g., for a square, the number of tracks is four. The smooth circular shape of a circle-shaped coil is approximated with a larger number of straight tracks, e.g., 24 tracks. More tracks can be used.

In step 663 in FIG. 16A, the PCB coil design solution generation engine 703 calculates the step angle (θ), which is the subtend angle between line segment endpoints for the line segments that make up the coil, the increment factor (r), which is the amount the radius of the coil increases for each line segment, and the offset radius adjusted on grid.

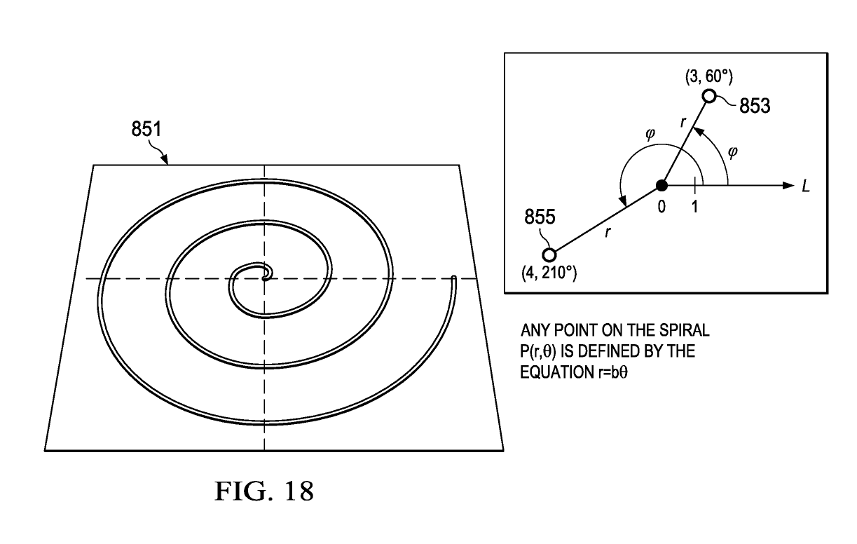

For illustrative purposes, consider a simple spiral 851 as illustrated in FIG. 18. Any point on the spiral, e.g., points 853 and 855, have locations defined in polar coordinates as P (rₚ, θₚ) where rₚ is a radius at the point P and θₚ is an angle with respect the positive x-axis and ranges from 0 to 2πN radians, where 2π equals one full turn and N is the number of turns per layer. The radius r is defined by r=bθ, which requires the determination of the value b.

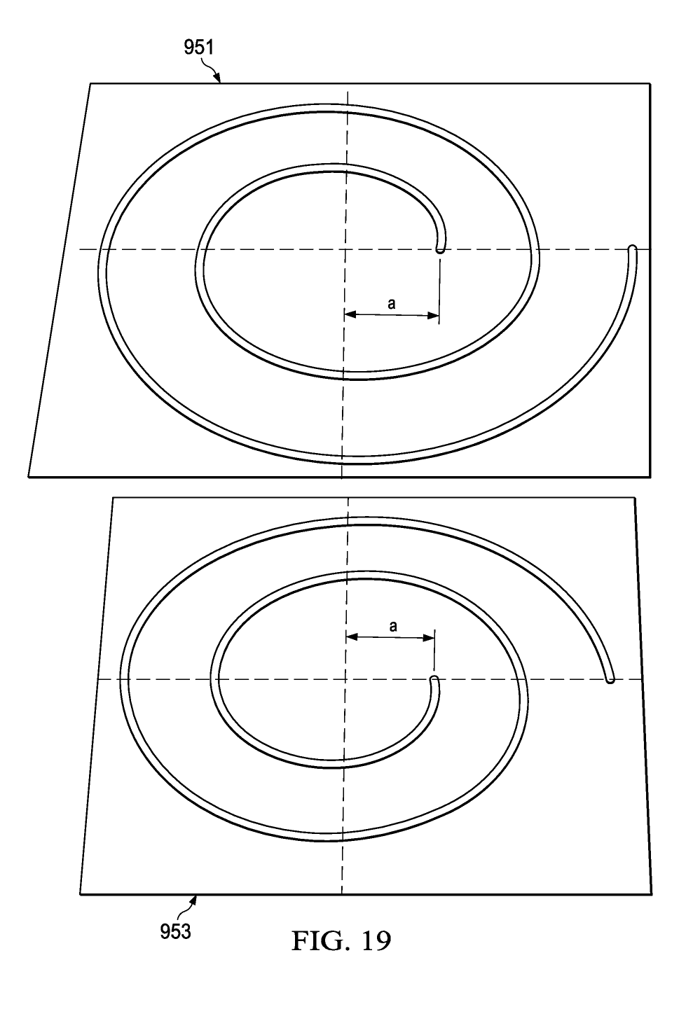

Consider an anticlockwise spiral 951 with an inner offset a equal to the inner diameter of the coil as is illustrated in FIG. 19. For an anticlockwise spiral any point on the spiral P(rₚ, θₚ) is defined by Equation (3):

rₚ=a+bθₚ (3)

### Where

$$a = innerDiameter , b = \frac{outerDiameter - innerDiameter}{N} ,$$

and θₚ=0→2πN, where N is the number of turns.

Conversely, consider a clockwise spiral 953 with an inner offset equal to the inner diameter of the coil as is illustrated in FIG. 19. For a clockwise spiral any point, P(r, θ), on the spiral is defined by Equation 4:

rₚ=a+bθₚ (4)

### Where

$$a = innerDiameter , b = \frac{outerDiameter - innerDiameter}{N} ,$$

and θp=θ→−2πN, where N is the number of turns.

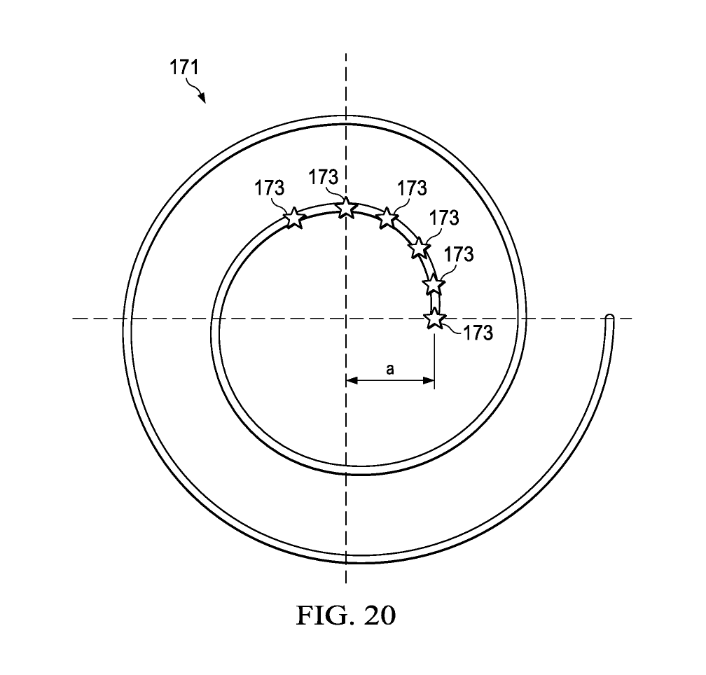

Equations 3 and 4 are for idealized spirals with infinitely many points. In one embodiment, the spirals are laid out as straight-line segments, referred to as tracks, each track located between adjacent vertices in a sequence of vertices. FIG. 20 illustrates the placement of such line segment endpoints on a counterclockwise spiral 171. Each of the points 173 is located on the spiral 171. The respective coordinates are defined by Equation 5:

rₚ=a+bθₚ (5)

### Where:

$$a = innerDiameter , b = \frac{outerDiameter - innerDiameter}{N} ,$$

and θₚ=0→2πN, in steps of

$$\frac{2 π}{T} ,$$

which is the step angle, θ, for an counterclockwise coil. Conversely, for a clockwise spiral coil, the angle increment is

$$- \frac{2 π}{T} .$$

N is the number of turns, T is the number of sides per turn of the polygon and b is the radial increment from one turn to the next turn.

Referring now to FIG. 16B, having determined the increment factor (r), the step angle (θ), and the offset radius (a) in step 663 in FIG. 16A, the process proceeds in FIG. 16B with laying out tracks that make up each of the layers of the coils. There are two loops in the process: an outer loop 665, which loops over all layers in the coil design, and an inner loop 666, which loops over all tracks for each layer in the coil design.

In the outer loop 665, in a step 667, the PCB coil design solution generation engine 703 determines the winding direction, which is used to determine whether the step angle should be positive or negative. If the spiral winding direction is clockwise, the step angle (θ) is

$$- \frac{2 π}{T}$$

(step 668), and if the spiral winding direction is counterclockwise, the step angle (θ) is

$$+ \frac{2 π}{T}$$

(step 669).

For each track (each track is processed in the inner loop 666), in a step 670, the PCB coil design solution generation engine 703 calculates the x and y coordinates for the endpoints (x₁,y₁) and (x₂,y₂) of each track and saves the track to the coil layout 806 (indicated below as a call to CreateTrack procedure), by:

FOR I=N*T→0
x₁=(I*b+a)*cos(I*θ)
y₁=(I*b+a)*sin(I*θ)
x₂=((I−1)*b+a)*cos((I−1)*θ)
y2=((I−1)*b+a)*sin((I−1)*θ)
CreateTrack (x₁, y₁, x₂, y₂,W,Layer)
where W is the track width and Layer is the current layer being processed by loop 665.

Having laid out the coil layers by completing the outer loop 665 and the inner loop 666, the PCB coil design solution generation engine 703 has determined a sequence of x, y coordinates corresponding to the endpoints that make up each layer of the PCB coil such as 105.

In a step 671, the PCB coil design solution generation engine 703 lays out related circuitry such as connecting vias, CSensor pad, tracks connecting the coil to the vias and CSensor.

In a step 672, the PCB coil design solution generation engine 703 writes the coil design to an XML output file.

In a step 673, the PCB coil design solution generation engine 703 generates a layout from the XML file. In step 674, the layout is formatted for the PCB design program being used to design the PCB.

A circuit design tool has been described herein that provides a mechanism to efficiently design and prototype circuit components used for sensing purposes, for example, in designing touch devices for user inputs in household appliances. Other sensor applications can be supported using the coil design tools of the embodiments.

The following section “CALCULATIONS” presents calculations and example code segments useful for performing calculations for use with the embodiments and referred to in the description hereinabove. In the CALCULATIONS section, Constants are shown in Bold and Current Values from the user interface input menu are shown in Italics.

CALCULATIONS

```
  Initial Calculations
  InnerDia_Min = 0
    OR
      //via condition (same as that for export)
      // Calculate via dimensions
      viaSizeLowerLimit = 24.0;
      viaSizeUpperLimit = 40.0;
      viaSize = TraceWidth * 6.0;
    if (viaSize > viaSizeUpperLimit) {
      viaSize = viaSizeUpperLimit;
    } else if (viaSize < viaSizeLowerLimit) {
      viaSize = viaSizeLowerLimit;
    }
    viaSpacing = viaSize * 0.5;
    viaMetSpacing = viaSpacing;
  // Calculate via dimensions − end
    numVias = NumLayers*0.5
```

| | |
|---|---|
| InnerDia_Min = numVias*viaSize + (numVias-1)viaSpacing | + |

```
2*viaMetSpacing
  GRAPH : X-axis range
  /* OuterDiameter on xaxis */
```

| | |
|---|---|
| Xaxis_min = InnerDia_Min | + |

2*NumTurns*(TraceWidth+TraceSpacing) + TraceWidth−TraceSpacing

| | |
|---|---|
| Xaxis_min_Turns = InnerDia | + |
| 2*NumTurns_min*(TraceWidth + TraceSpacing) + TraceWidth | − |

TraceSpacing
Xaxis_max = OuterDia_max

| | |
|---|---|
| Xaxis_max_Turns = Dᵢₙ | + |
| 2*NumTurns_max*(TraceWidth+TraceSpacing) +TraceWidth | − |

```
TraceSpacing
  if yaxis=numTurns {
    Xaxis_min = Xaxis_min_Turns
    Xaxis_max = Xaxis_max_Turns
  } elseif yaxis=outerDia {
    // nothing
    // because this case does not occur
  } else {
    Xaxis_max = Xaxis_max
    Xaxis_min = Xaxis_min
  }
  /* NumTurns on xaxis */
    Xaxis_min = NumTurns_min
    Xaxis_min_OuterDia = OuterDia_Min − Dᵢₙ − TraceWidth +
TraceSpacing /(2*(TraceWidth+TraceSpacing) )
    Xaxis_max = OuterDia − InnerDia_min − TraceWidth +
TraceSpacing /(2*(TraceWidth+TraceSpacing) )
    Xaxis_max_OuterDia = OuterDia_max − Dᵢₙ − TraceWidth +
TraceSpacing /(2*(TraceWidth+TraceSpacing) )
    if yaxis = numTurns {
      // nothing
      // coz this case does not occur
} elseif yaxis=outerDia {
    Xaxis_min = Xaxis_min_OuterDia
    Xaxis_max = Xaxis_max_OuterDia
  } else {
    Xaxis_max = Xaxis_max
    Xaxis_min = Xaxis_min
  }
  TraceWidth on xaxis
    Xaxis_min = TraceWidth_min
    Xaxis_ min_OuterDia =
    OuterDia_min -InnerDia− TraceSpacing*(2*Numturns -1)
/(2*Numturns+1)
    Xaxis_ min_Turns =
    OuterDia -InnerDia− TraceSpacing*(2*Numturns_max -
1)/(2*Numturns_max+1)
    Xaxis_max = OuterDia - InnerDia_Min −
TraceSpacing*(2*Numturns -1) /(2*Numturns+1)
    Xaxis_ max_OuterDia =
    OuterDia_max -InnerDia− TraceSpacing*(2*Numturns -1)
/(2*Numtums+1)
    Xaxis_ max_Turns =
    OuterDia -InnerDia− TraceSpacing*(2*Numturns_min -1)
/(2*Numturns_min+1)
  if yaxis=numTurns {
    Xaxis_min = Xaxis_min_Turns
    Xaxis_max = Xaxis_max_Turns
    } elseif yaxis=outerDia {
    Xaxis_min = Xaxis_min_OuterDia
    Xaxis_max = Xaxis_max_OuterDia
  } else {
    Xaxis_max = Xaxis_max
    Xaxis_min = Xaxis_min
  }
  TraceSpacing on xaxis
    Xaxis_min = TraceSpacing_min
    Xaxis_ min_OuterDia =
    OuterDia_min -InnerDia− TraceWidth*(2*Numturns +1)
/(2*Numtums -1)
    Xaxis_ min_Turns =
    OuterDia -InnerDia− TraceWidth*(2*Numturns_max +1)
/(2*Numturns_max -1)
    Xaxis_max = OuterDia - InnerDia_Min −
TraceWidth*(2*Numturns +1)/(2*Numturns -1)
    Xaxis_ max_OuterDia =
    OuterDia_max -InnerDia− TraceWidth*(2*Numturns +1)
/(2*Numturns -1)
    Xaxis_ max_Turns =
    OuterDia -InnerDia− TraceWidth*(2*Numturns_min +1)
/(2*Numturns_min -1)
  if yaxis=numTurns {
    Xaxis_min = Xaxis_min_Turns
    Xaxis_max = Xaxis_max_Turns
  } elseif yaxis=outerDia {
    Xaxis_min = Xaxis_min_OuterDia
    Xaxis_max = Xaxis_max_OuterDia
  } else {
    Xaxis_max = Xaxis_max
    Xaxis_min = Xaxis_min
  }
  X-axis range
  NumLayers
    Xaxis_min = NumLayers_Min
    Xaxis_max = NumLayers_Max
  Temperature
    Xaxis_min = Temperature_Min
    Xaxis_max = Temperature_Max
  SensorCap
    Xaxis_min = SensorCap_Min
    Xaxis_max = SensorCap_Max
  CuThickness
    Xaxis_min = CuThickness_Min
    Xaxis_max = CuThickness_Max
  Voltage
    Xaxis_min = Voltage_Min
    Xaxis_max = Voltage_Max
```

The following section, “PARAMETER VALUE RELATIONSHIPS,” presents equations useful to perform calculations needed to graph various parameters as described hereinabove. Each parameter value relationship section begins with a descriptive header in Bold Italics Underlined. In the parameter relationship formulas, constants are shown in Bold, current values with inputs received from user interface input boxes are shown in Italics, and values for which a functional relationship is to be plotted are shown in Italics Underline. The type of plot used for each parameter relationship is indicated in the “Type” field.

In the section Parameter Value Relationships, the following symbols are used:
Dᵢₙ—Inner Diameter
Dₒᵤₜ—Outer Diameter
N—Number of Turns
W—Trace Width
S—Trace Spacing
T—Tracks per Turn
M—Number of Layers
L—Total Inductance
F—Sensor Frequency
C—Capacitance

PARAMETER VALUE RELATIONSHIPS

[symbol]

Dₒᵤₜ = (2 * N + 1) * W + Dᵢₙ + (2 * N − 1) * S
(Type: y = mx + c; Positive slope)

[symbol]

Dₒᵤₜ = (2 * N − 1) * S + Dᵢₙ + (2 * N + 1) * W
(Type: y = mx + c; Positive slope)

[symbol]

Dₒᵤₜ (2 * W + S) * N + Dᵢₙ + W − S
(Type: y = mx + c; Positive slope)

[symbol]

$\underline{N} = \frac{\underline{{D}_{out}}}{( 2 * W + S )} - \frac{{D}_{in} + W - S}{2 * ( W + S )}$
(Type: y= mx + c; Positive slope)

[symbol]

$\underline{N} = \frac{{D}_{out} - {D}_{in} + S -}{( 2 * \underline{W} + 2 * S )}$
Note: the W (TraceWidth) term in the numerator has a strikethrough
as it is a term with negligible effect on the end result and may be ignored.
(Type: y = a/(bx + c))

[symbol]

$\underline{N} = \frac{{D}_{out} - {D}_{in} + - W}{( 2 * W + 2 * \underline{S} )}$
Note: the S (TraceSpacing) term in the numerator has a strikethrough
as it is a term with negligible effect on the end result and may be ignored.
(Type: y = a/(bx + c))

[symbol]

TotalInductance ∝ OuterDia
(Approximate type: y = mx + c; positive slope)
Which follows from Mohan's Equation (see, Note below):
L = [(μ₀N²D_{AVG}C₁)/2][ln(C₂/ρ) + C₃ρ + C₄ρ²]
Where: L is the total inductance μ₀ is the permeability of free space, 4π ×
10^{-7,} N is the number of turns of the coil, D_{avg} is the average diameter =
(Dₒᵤₜ + Dᵢₙ)/2, C₁, C₂, C₃, C₄ are layout dependent factors based on the
geometry of the coil (for a circle, the following values are appropriate:
C₁ = 1.0, C₂ = 2.46, C₃ = 0, C₄ = 0.2). C coefficients for other shapes
may be found in [Mohan]; ρ is (dₒᵤₜ − dᵢₙ)/dₒᵤₜ + dᵢₙ), and represents the
fill ration of the inductor - small values of ρ correspond to hollow
inductors (dₒᵤₜ ≈ dᵢₙ), while large values correspond to (dₒᵤₜ ≈ dᵢₙ).
Note: The equation for L provided herein may be derived from Mohan's
Equation, as discussed in [Mohan] S. S. Mohan, M. del Mar Hersheson,
S. P. Boyd, and T. H. Lee, “Simple Accurate Expressions for Planar
Spiral Inductances,” IEEE Journal of Solid-state Circuits, vol 34, no.
10, pp 1419-1424, Oct. 1999 (the entire disclosure of which is
incorporated herein by reference)

[symbol]

TotalInductance ∝ −TraceWidth
(Approximate type: y = mx + c; negative slope)
Which also follows from Mohan's Equation:
L = [(μ₀N²D_{AVG}C₁)/2][ln(C₂/ρ) + C₃ρ + C₄ρ²]

[symbol]

TotalInductance ∝ −TraceSpacing
(Approximate type: y = mx + c; negative slope)
Which also follows from Mohan's Equation:
L = [(μ₀N²D_{AVG}C₁)/2][ln(C₂/ρ) + C₃ρ + C₄ρ²]

[symbol]

TotalInductance ∝ NumTurns²
(Approximate type: y = mx² + c)
Which also follows from Mohan's Equation:
L = [(μ₀N²D_{AVG}C₁)/2][ln(C₂/ρ) + C₃ρ + C₄ρ²]

[symbol]

TotalInductance ∝ NumLayers
Which also follows from Mohan's Equation:
L = [(μ₀N²D_{AVG}C₁)/2][ln(C₂/ρ) + C₃ρ + C₄ρ²]

[symbol]

SensorFrequency ∝ OuterDia
(same as TotalInductance vs OuterDia)
(Approximate type: y = mx + c; positive slope)
Which follows from Mohan's Equation:
L = [(μ₀N²D_{AVG}C₁)/2][ln(C₂/ρ) + C₃ρ + C₄ρ²]
SensorFrequency v. TraceWidth
SensorFrequency ∝ −TraceWidth
(same as TotalInductance vs TraceWidth)
(Approximate type: y = mx + c; positive slope)
Which follows from Mohan's Equation:
L = [(μ₀N²D_{AVG}C₁)/2][ln(C₂/ρ) + C₃ρ + C₄ρ²]
SensorFrequency v. TraceSpacing
SensorFrequency ∝ −TraceSpacing
(same as TotalInductance vs TraceSpacing)
(Approximate type: y = mx + c; positive slope)
Which follows from Mohan's Equation:
L = [(μ₀N²D_{AVG}C₁)/2][ln(C₂/ρ) + C₃ρ + C₄ρ²]
SensorFrequency v. NumTurns
SensorFrequency ∝ NumTurns
(Approximate type: y = c − mx²)
SensorFrequency v. NumLayers
SensorFrequency ∝ NumLayers
SensorFrequency v. SensorCapacitance
SensorFrequency ∝ 1/\sqrt{SensorCapacitance}

[symbol]

$\underline{DcResistance} = \frac{M * 2 * π * {ρ}_{cu}}{W * CuThicness} * [ \underline{{D}_{out}} * N - {N}^{2} * ( W + S ) ]$
Type: y = mx + c; Positive Slope

[symbol]

$\underline{DcResistance} = \frac{M * 2 * π * {ρ}_{cu}}{W * CuThicness} * [ {D}_{out} * N - {N}^{2} * ( \underline{W} + S ) ]$
$Type \text{:} y = \frac{a}{x} - b$

[symbol]

$\underline{DcResistance} = \frac{M * 2 * π * {ρ}_{cu}}{W * CuThicness} * [ {D}_{out} * N - {N}^{2} * ( W + \underline{S} ) ]$
Type: y = mx + c; Negative Slope

[symbol]

$\underline{DcResistance} = \frac{M * 2 * π * {ρ}_{cu}}{W * CuThicness} * [ {D}_{out} * \underline{N} - {\underline{N}}^{2} * ( W + S ) ]$
Type: y = ax + bx²

[symbol]

$\underline{DcResistance} = \frac{\underline{M} * 2 * π * {ρ}_{cu}}{W * CuThicness} * [ {D}_{out} * N - {N}^{2} * ( W + S ) ]$
Type: y = mx; Positive Slope

[symbol]

$\underline{DcResistance} = \frac{M * 2 * π * \underline{{ρ}_{cu}}}{W * CuThicness} * [ {D}_{out} * N - {N}^{2} * ( W + S ) ]$
Type: y = mx; Positive Slope

[symbol]

$AcResistance = \frac{a * Temperature * M * [ \underline{{D}_{out}} * N - {N}^{2} * ( W + S ) ]}{W * \sqrt{\underline{L} C} * ( 1 - {e}^{b * CuThickness / \underline{L} C} )}$
$Approximate Type \text{:} y = \frac{ax + b}{\sqrt{x} ( 1 - {e}^{c / \sqrt{x}} )}$
Note: L = [(μ₀N²D_{AVG}C₁)/2][ln(C₂/ρ) + C₃ρ + C₄ρ²]
Therefore, L depends on the OuterDia value also, which is the reason
L is underlined in the equation above.

[symbol]

$AcResistance = \frac{a * Temperature * M * [ {D}_{out} * N - {N}^{2} * ( \underline{W} + S ) ]}{W * \sqrt{\underline{L} C} * ( 1 - {e}^{b * CuThickness / \underline{L} C} )}$
$Approximate Type \text{:} y = \frac{ax - b}{x * \sqrt{x} ( 1 - {e}^{c / \sqrt{x}} )}$
Note: L = [(μ₀N²D_{AVG}C₁)/2][ln(C₂/ρ) + C₃ρ + C₄ρ²]
Therefore, L depends on the TraceWidth value also, which is why L is
underlined in the equation above.

[symbol]

$AcResistance = \frac{a * Temperature * M * [ {D}_{out} * N - {N}^{2} * ( W + \underline{S} ) ]}{W * \sqrt{\underline{L} C} * ( 1 - {e}^{b * CuThickness / \underline{L} C} )}$
$Approximate Type \text{:} y = \frac{a - bx}{\sqrt{x} ( 1 - {e}^{c / \sqrt{x}} )}$
Note: L = [(μ₀N²D_{AVG}C₁)/2][ln(C₂/ρ) + C₃ρ + C₄ρ²]
Therefore, L depends on the TraceSpacing value also, which is why L
is underlined in the equation above.

[symbol]

$AcResistance = \frac{a * Temperature * M * [ {D}_{out} * \underline{N} - {\underline{N}}^{2} * ( W + \underline{S} ) ]}{W * \sqrt{\underline{L} C} * ( 1 - {e}^{b * CuThickness / \underline{L} C} )}$
$Approximate Type \text{:} y = \frac{ax - {bx}^{2}}{x ( 1 - {e}^{c / x} )}$
Note: L = [(μ₀N²D_{AVG}C₁)/2][ln(C₂/ρ) + C₃ρ + C₄ρ²]
Therefore, L depends on the NumTurns value also, which is why L is
underlined in the equation above.

[symbol]

$AcResistance = \frac{a * Temperature * \underline{M} * [ {D}_{out} * N - {N}^{2} * ( W + S ) ]}{W * \sqrt{\underline{L} C} * ( 1 - {e}^{b * CuThickness / \underline{L} C} )}$
$Approximate Type \text{:} y = \frac{a \sqrt{x}}{( 1 - {e}^{b / x} )}$
Note: L = [(μ₀N²D_{AVG}C₁)/2][ln(C₂/ρ) + C₃ρ + C₄ρ²]
Therefore, L depends on the NumLayers value also, which is why L is
underlined in the equation above.

[symbol]

$AcResistance = \frac{a * Temperature * M * [ {D}_{out} * N - {N}^{2} * ( W + S ) ]}{W * \sqrt{L \underline{C}} * ( 1 - {e}^{b * CuThickness / L \underline{C}} )}$
$Approximate Type \text{:} y = \frac{a}{\sqrt{x} ( 1 - {e}^{b / \sqrt{x}} )}$

[symbol]

$AcResistance = \frac{a * \underline{Temperature} * M * [ {D}_{out} * N - {N}^{2} * ( W + S ) ]}{W * \sqrt{L \underline{C}} * ( 1 - {e}^{b * CuThickness / L \underline{C}} )}$
Approximate Type: y = mx
Note: C depends on the Temperature also, which is why C is underlined
in the equation above.

[symbol]

$AcResistance = \frac{a * Temperature * M * [ {D}_{out} * N - {N}^{2} * ( W + S ) ]}{W * \sqrt{L \underline{C}} * ( 1 - {e}^{b * \underline{CuThickness} / L \underline{C}} )}$
$Approximate Type \text{:} y = \frac{a}{( 1 - {e}^{bx} )}$
Note: C depends on the CuThickness also, which is why C is underlined
in the equation above.

[symbol]

$\underline{QFactor} = \frac{W * \underline{L} * ( 1 - {e}^{b * CuThickness / \sqrt{\underline{L} C}} )}{a * Temperature * M * [ \underline{{D}_{out}} * N - {N}^{2} * ( W + S ) ]}$
$Approximate Type \text{:} y = \frac{x ( 1 - {e}^{c / \sqrt{x}} )}{ax + b}$

[symbol]

$\underline{QFactor} = \frac{\underline{W} * \underline{L} * ( 1 - {e}^{b * CuThickness / \sqrt{\underline{L} C}} )}{a * Temperature * M * [ {D}_{out} * N - {N}^{2} * ( \underline{W} + S ) ]}$
$Approximate Type \text{:} y = \frac{{x}^{2} ( 1 - {e}^{c / \sqrt{x}} )}{a - bx}$

[symbol]

$\underline{QFactor} = \frac{W * \underline{L} * ( 1 - {e}^{b * CuThickness / \sqrt{\underline{L} C}} )}{a * Temperature * M * [ {D}_{out} * N - {N}^{2} * ( W + \underline{S} ) ]}$
$Approximate Type \text{:} y = \frac{x ( 1 - {e}^{c / \sqrt{x}} )}{a - bx}$

[symbol]

$\underline{QFactor} = \frac{W * \underline{L} * ( 1 - {e}^{b * CuThickness / \sqrt{\underline{L} C}} )}{a * Temperature * M * [ {D}_{out} * \underline{N} - {\underline{N}}^{2} * ( W + S ) ]}$
$Approximate Type \text{:} y = \frac{{x}^{2} ( 1 - {e}^{c / \sqrt{x}} )}{ax - {bx}^{2}}$

[symbol]

$\underline{QFactor} = \frac{W * \underline{L} * ( 1 - {e}^{b * CuThickness / \sqrt{\underline{L} C}} )}{a * Temperature * \underline{M} * [ {D}_{out} * N - {N}^{2} * ( W + S ) ]}$
$Approximate Type \text{:} y = a ( 1 - {e}^{b / \sqrt{x}} )$

[symbol]

$\underline{QFactor} = \frac{\underline{W} * \underline{L} * ( 1 - {e}^{b * CuThickness / \sqrt{\underline{L} C}} )}{a * Temperature * M * [ {D}_{out} * N - {N}^{2} * ( \underline{W} + S ) ]}$
$\underline{QFactor} = \frac{TraceWidth * L * ( 1 - {e}^{b * CuThickness / \sqrt{L \underline{C}}} )}{a * Temperature * NumLayers * [ \frac{OuterDia * NumTurns -}{{NumTurns}^{2} * ( \begin{matrix}TraceWidth + \\ TraceSpacing\end{matrix} )} ]}$
$Approximate Type \text{:} y = a ( 1 - {e}^{b / \sqrt{x}} )$

[symbol]

$\underline{QFactor} = \frac{W * L * ( 1 - {e}^{b * CuThickness / \sqrt{LC}} )}{a * \underline{Temperature} * M * [ {D}_{out} * N - {N}^{2} * ( W + S ) ]}$
$Approximate Type \text{:} y = \frac{a}{x}$

[symbol]

$\underline{QFactor} = \frac{W * L * ( 1 - {e}^{b * \underline{CuThickness} / \sqrt{LC}} )}{a * Temperature * M * [ {D}_{out} * N - {N}^{2} * ( W + S ) ]}$
Approximate Type: y = a(1 − e^{bx})
ResonanceImpedence v. OuterDia
$\underline{ResonanceImpedence} = \frac{W * \underline{L} * \sqrt{\frac{\underline{L}}{C}} * ( 1 - {e}^{b * CuThickness / \sqrt{\underline{L} C}} )}{a * Temperature * M * [ \underline{{D}_{out}} * N - {N}^{2} * ( W + S ) ]}$
$Approximate Type \text{:} y = \frac{x \sqrt{x} ( 1 - {e}^{c / \sqrt{x}} )}{ax + b}$

[symbol]

$\underline{ResonanceImpedence} = \frac{\underline{W} * \underline{L} * \sqrt{\frac{\underline{L}}{C}} * ( 1 - {e}^{b * CuThickness / \sqrt{\underline{L} C}} )}{a * Temperature * M * [ {D}_{out} * N - {N}^{2} * ( \underline{W} + S ) ]}$
$Approximate Type \text{:} y = \frac{{x}^{2} \sqrt{x} ( 1 - {e}^{c / \sqrt{x}} )}{a - bx}$

[symbol]

$\underline{ResonanceImpedence} = \frac{W * \underline{L} * \sqrt{\frac{\underline{L}}{C}} * ( 1 - {e}^{b * CuThickness / \sqrt{\underline{L} C}} )}{a * Temperature * M * [ {D}_{out} * N - {N}^{2} * ( W + \underline{S} ) ]}$
$Approximate Type \text{:} y = \frac{x \sqrt{x} ( 1 - {e}^{c / \sqrt{x}} )}{a - bx}$

[symbol]

$\underline{ResonanceImpedence} = \frac{W * \underline{L} * \sqrt{\frac{\underline{L}}{C}} * ( 1 - {e}^{b * CuThickness / \sqrt{\underline{L} C}} )}{a * Temperature * M * [ {D}_{out} * \underline{N} - {\underline{N}}^{2} * ( W + S ) ]}$
$Approximate Type \text{:} y = \frac{{x}^{2} \sqrt{x} ( 1 - {e}^{c / \sqrt{x}} )}{a - bx}$

[symbol]

$\underline{ResonanceImpedence} = \frac{W * \underline{L} * \sqrt{\frac{\underline{L}}{C}} * ( 1 - {e}^{b * CuThickness / \sqrt{\underline{L} C}} )}{a * Temperature * \underline{M} * [ {D}_{out} * N - {N}^{2} * ( W + S ) ]}$
$Approximate Type \text{:} y = a \sqrt{x} ( 1 - {e}^{b / \sqrt{x}} )$

[symbol]

$\underline{ResonanceImpedance} = \frac{W * L * \sqrt{\frac{L}{\underline{C}}} * ( 1 - {e}^{b * CuThickness / \sqrt{L \underline{C}}} )}{a * Temperature * M * [ {D}_{out} * N - {N}^{2} * ( W + S ) ]}$
$Approximate Type \text{:} y = \frac{a ( 1 - {e}^{b / \sqrt{x}} )}{\sqrt{x}}$

[symbol]

$\underline{ResonanceImpedance} = \frac{W * L * \sqrt{\frac{L}{C}} * ( 1 - {e}^{b * CuThickness / \sqrt{LC}} )}{a * \underline{Temperature} * M * [ {D}_{out} * N - {N}^{2} * ( W + S ) ]}$
$Approximate Type \text{:} y = \frac{a}{x}$

[symbol]

$\underline{ResonanceImpedance} = \frac{W * L * \sqrt{\frac{L}{C}} * ( 1 - {e}^{b * \underline{CuThickness} / \sqrt{LC}} )}{a * Temperature * M * [ {D}_{out} * N - {N}^{2} * ( W + S ) ]}$
Approximate Type: y = a(1 − e^{bx})

[symbol]

$\underline{PowerDissipaton} = \frac{a * {V}^{2} * Temp * M * [ \underline{{D}_{out}} * N - {N}^{2} * ( W + S ) ]}{W * \underline{L} * \sqrt{\frac{\underline{L}}{C}} * ( 1 - {e}^{b * CuThickness / \sqrt{\underline{L} C}} )}$
V—Voltage
Temp—Temperature
$Approximate Type \text{:} y = \frac{ax + b}{x \sqrt{x} ( 1 - {e}^{c / \sqrt{x}} )}$

[symbol]

$\underline{PowerDissipaton} = \frac{a * {V}^{2} * Temp * M * [ {D}_{out} * N - {N}^{2} * ( \underline{W} + S ) ]}{\underline{W} * \underline{L} * \sqrt{\frac{\underline{L}}{C}} * ( 1 - {e}^{b * CuThickness / \sqrt{\underline{L} C}} )}$
V—Voltage
T—Temperature
$Approximate Type \text{:} y = \frac{a - bx}{x \sqrt{x} ( 1 - {e}^{c / \sqrt{x}} )}$

[symbol]

$\underline{PowerDissipaton} = \frac{a * {V}^{2} * Temp * M * [ {D}_{out} * N - {N}^{2} * ( W + \underline{S} ) ]}{W * \underline{L} * \sqrt{\frac{\underline{L}}{C}} * ( 1 - {e}^{b * CuThickness / \sqrt{\underline{L} C}} )}$
V—Voltage
T—Temperature
$Approximate Type \text{:} y = \frac{a - bx}{x \sqrt{x} ( 1 - {e}^{c / \sqrt{x}} )}$

[symbol]

$\underline{PowerDissipaton} = \frac{a * {V}^{2} * Temp * M * [ {D}_{out} * \underline{N} - {\underline{N}}^{2} * ( W + S ) ]}{W * \underline{L} * \sqrt{\frac{\underline{L}}{C}} * ( 1 - {e}^{b * CuThickness / \sqrt{\underline{L} C}} )}$
V—Voltage
T—Temperature
$Approximate Type \text{:} y = \frac{ax + {bx}^{2}}{{x}^{3} ( 1 - {e}^{c / x} )}$

[symbol]

$\underline{PowerDissipaton} = \frac{a * {V}^{2} * Temp * \underline{M} * [ {D}_{out} * N - {N}^{2} * ( W + S ) ]}{W * \underline{L} * \sqrt{\frac{\underline{L}}{C}} * ( 1 - {e}^{b * CuThickness / \sqrt{\underline{L} C}} )}$
V—Voltage
T—Temperature
$Approximate Type \text{:} y = \frac{a}{\sqrt{x} ( 1 - {e}^{b / \sqrt{x}} )}$

[symbol]

$= \frac{a * {V}^{2} * Temp * M * [ {D}_{out} * N - {N}^{2} * ( W + S ) ]}{W * L * \sqrt{\frac{L}{\underline{C}}} * ( 1 - {e}^{b * CuThickness / \sqrt{L \underline{C}}} )}$
V—Voltage
Temp—Temperature
$Approximate Type \text{:} y = \frac{a \sqrt{x}}{( 1 - {e}^{b / \sqrt{x}} )}$

[symbol]

$\underline{PowerDissipaton} = \frac{a * {V}^{2} * \underline{Temp} * M * [ {D}_{out} * N - {N}^{2} * ( W + S ) ]}{W * L * \sqrt{\frac{L}{C}} * ( 1 - {e}^{b * CuThickness / \sqrt{LC}} )}$
V—Voltage
Temp—Temperature
Approximate Type: y = mx

[symbol]

$\underline{PowerDissipaton} = \frac{a * {V}^{2} * Temp * M * [ {D}_{out} * N - {N}^{2} * ( W + S ) ]}{W * L * \sqrt{\frac{L}{C}} * ( 1 - {e}^{b * \underline{CuThickness} / \sqrt{LC}} )}$
V—Voltage
Temp—Temperature
$Approximate Type \text{:} y = \frac{a}{( 1 - {e}^{bx} )}$

[symbol]

$\underline{PowerDissipaton} = \frac{a * {\underline{V}}^{2} * Temp * M * [ {D}_{out} * N - {N}^{2} * ( W + S ) ]}{W * L * \sqrt{\frac{L}{C}} * ( 1 - {e}^{b * CuThickness / \sqrt{LC}} )}$
V—Voltage
T—Temperature
Approximate Type: y = ax²

Modifications are possible in the described embodiments, and other embodiments are possible within the scope of the claims.

What is claimed is:

1. A method, comprising:
in a computerized printed circuit board (PCB) coil circuit design system:
setting PCB coil design parameters based on PCB manufacturing rules including at least trace width and conductor thickness;
receiving user input parameters including inductor-capacitor (LC) sensor capacitance, coil shape, and number of coil layers;
calculating output coil parameters including total inductance, sensor frequency, and Q factor as a function of the PCB coil design parameters and of the received user input parameters;
graphically plotting at least one selected output coil parameter as a function of at least one input coil parameter; and
receiving an update to at least one parameter selected from the parameters based on PCB manufacturing rules and user input parameters, and in response to receiving the update of at least one parameter, recalculating the output coil parameters and replotting the at least one selected output coil parameter as a function of at least one input coil parameter.

2. The method of claim 1, in which setting the conductor thickness parameter further includes setting a copper thickness.

3. The method of claim 1 and further comprising:
receiving an updated selection of output coil parameter or input coil parameter used in graphically plotting the at least one selected output coil parameter as a function of at least one input coil parameter, and updating the graphical plotting of the at least one selected output coil parameter as a function of at least one input coil parameter based on the updated selection.

4. The method of claim 1 in which the coil shape is selected by a user from the set including: circular; racetrack; and polygons including triangular, square, hexagon, octagon, triangular, and stretched polygons.

5. The method of claim 1 in which calculating output coil parameters further includes determining the number of coil layers as a function of the number of coil layers user input parameter.

6. The method of claim 1 and further comprising:
generating a coil layout based on the user input parameters and generated output parameters in which the coil layout is a set of connected straight-line segments.

7. The method of claim 6 and further comprising:
receiving a user input indicating the method is to output a computer automated design (CAD) file based on generated coil layout and, in response to the user input indication, producing a CAD file based on the coil layout.

8. A PCB coil produced by the method of:
setting parameters based on PCB manufacturing rules including trace width and copper thickness;
receiving user input parameters including an inductor-capacitor (LC) sensor capacitance, coil shape, and number of coil layers;
calculating output coil parameters including total inductance, sensor frequency, and Q factor as a function of the PCB coil design parameters and received user input parameters;
graphically plotting at least one selected output coil parameter as a function of at least one input coil parameter;
receiving an update to at least one parameter selected from the parameters based on PCB manufacturing rules and user input parameters, and in response to receiving the update of at least one parameter, recalculating the output coil parameters and replotting the at least one selected output coil parameter as a function of at least one input coil parameter;
generating a coil layout based on the user input and generated output parameter segments;
receiving a user input indicating to output a CAD file based on generated coil layout and, in response to the indication, producing a CAD file based on the coil layout; and
producing a coil on a PCB using the produced CAD file.

9. The PCB coil of claim 8 in which the method producing the PCB coil further includes:
generating the coil layout based on the user input parameters and generated output parameters in which the coil layout is a set of connected straight-line segments.

10. The PCB coil of claim 8 in which the method producing the PCB coil further includes:
receiving an updated selection of at least output coil parameter or at least input coil parameter used in graphically plotting at least one selected output coil parameter as a function of at least one input coil parameter; and
updating the graphical plotting of at least one selected output coil parameter as a function of at least one input coil parameter based on the updated selection.

11. The PCB coil of claim 8 in which in the method producing the PCB coil, the coil shape is selected from the set including circular, racetrack, and polygons including triangular, square, rectangular, hexagon, octagon, triangular, and stretched polygons.

12. The PCB coil of claim 8 in which the method producing the PCB coil further includes calculating output coil parameters which further includes the number of coil layers as a function of the number of coil layers user input parameter.

13. A computerized printed circuit board (PCB) coil circuit design system, comprising:
a user input engine:
to receive PCB coil design parameters based on PCB manufacturing rules including trace width and conductor thickness;
to receive user input parameters including inductor-capacitor (LC) sensor capacitance, coil shape, and number of coil layers; and
to receive updates to any of the PCB coil design parameters or the user input parameters; and
a PCB coil solution generation engine:
to calculate output coil parameters including total inductance, sensor frequency, and Q factor as a function of the PCB coil design parameters and received user input parameters;
to graphically plot one selected output coil parameter as a function of one input coil parameter; and
upon an update to one parameter selected from the parameters based on PCB manufacturing rule and user input parameters, to recalculate the output coil parameters and to replot the one selected output coil parameter as a function of one input coil parameter.

14. The computerized PCB coil circuit design system of claim 13, the PCB coil solution generation engine further to generate a coil layout based on the user input and generated output parameters in which the coil layout is a set of connected straight-line segments.

15. The computerized PCB coil circuit design system of claim 13, the user input engine further to receive an updated selection of output coil parameter or input coil parameter used in graphically plotting at least one selected output coil parameter as a function of at least one input coil parameter; and the PCB coil solution generation engine further to update the graphical plotting of at least one selected output coil parameter as a function of at least one input coil parameter based on the updated selection.

16. The computerized PCB coil system of claim 13, the PCB coil solution engine further to output a computer automated design (CAD) file corresponding to a coil determined by the PCB coil solution engine.

17. The computerized PCB coil system of claim 13, in which the coil shapes include one selected from the set including circular, racetrack, and polygons including triangular, square, rectangular, hexagon, octagon, triangular, as well as stretched polygons.

18. The computerized PCB coil system of claim 13, in which PCB coil design parameters based on PCB manufacturing rules include conductor thickness (t) comprising a thickness of a copper conductor.

19. The computerized PCB coil system of claim 13, in which PCB coil design parameters based on PCB manufacturing rules including trace width and conductor thickness include copper conductor thickness.
